(19) United States
(12) Patent Application Publication
(10) Pub. No.: US 2012/0221188 A1
(43) Pub. Date: Aug. 30, 2012

(54) VEHICLE HMI REPLACEMENT

(75) Inventor: James J. Kelly, III, Ferndale, MI (US)

(73) Assignee: General Motors LLC, Detroit, MI (US)

(21) Appl. No.: 13/034,391

(22) Filed: Feb. 24, 2011

(51) Int. Cl. G06F 7/00; H04B 7/00; G06F 3/048

(52) U.S. Cl. 701/29.1; 715/772; 455/41.2; 701/418; 701/431

(57) ABSTRACT

The described method and system provide for a removable computing device as part of a HMI of a vehicle which may be utilized to provide consumers with a personalized driving experience, comprehensive infotainment services, and a more sophisticated avenue for third parties to interact with the consumer. Specifically, the computing device may be a tablet computer, and may communicate with vehicle components wirelessly or through a wired connection and through a communications gateway or other interface. The tablet computer may be a general purpose computer with specific applications designed for vehicle-related functions stored on it. The tablet may provide the user with a plurality of functional interfaces, such as interfaces relating to conventional instrument gauges, heating, ventilation and air conditioning (HVAC) controls, a radio, infotainment services, diagnostics monitoring, and vehicle module reflashing.

### BACKGROUND OF THE INVENTION

Each year computing power continues to increase and the costs for computing devices continue to decrease, leading to a shortened, lifecycle for computing devices and leading to the consistent an ongoing adoption of more sophisticated technology by consumers. The popularity of smartphones, netbooks, tablet computing devices, laptops and other portable electronics devices continues to grow as consumers increasingly feel the need or desire to be electronically connected and available.

While the technology in newer vehicles is also rapidly becoming more sophisticated, a vehicle is a significant expense, and as such many consumers tend to own their vehicle for a long duration relative to other types of products, and thus as the current technology rapidly advances, vehicles may quickly lose their initial value and owners may perceive their vehicles becoming obsolete more quickly. Part of the problem may lie with the human-machine interface (HMI), and the accepted configuration of this interface as built-in hardware, conventionally including displays (such as the speedometer, tachometer, and fuel gauge) and controls (such as the steering wheel, pedals, radio interface, and air conditioning interface).

Even new vehicle models which include advanced features, such as those equipped with telematics units that allow the user of the vehicle to perform numerous tasks (such as diagnostics monitoring, conducting calls, getting directions, accessing infotainment services, etc.) may still be unable to keep up with the rapidly changing technological landscape. This is because those telematics units are conventionally made up of or embodied in hardware components that may also be difficult or costly to replace and update.

Thus, it is an object in part to provide a system and method for preventing a vehicle HMI from being made obsolete by the rapid pace of technological advancement more generally. However, while this is an object underlying certain implementations of the invention, it will be appreciated that the invention is not limited to systems that solve the problems noted herein. Moreover, the inventors have created the above body of information for the convenience of the reader and expressly disclaim all of the foregoing as prior art; the foregoing is a discussion of problems discovered and/or appreciated by the inventors, and is not an attempt to review or catalog the prior art.

### BRIEF SUMMARY OF THE INVENTION

The invention provides a system and method for utilizing a computing device as part of a HMI of a vehicle to provide consumers with a personalized driving experience, comprehensive infotainment services, and a more sophisticated avenue for interacting. The computing device may be a tablet computer in one implementation, a laptop computer in another implementation, and other types of portable computers and electronics devices in other implementations. In different implementations, the computing device may communicate with vehicle components wirelessly or through a wired connection, and may communicate with components through a communications gateway or other interface. The computing device may further be a general purpose computing device that a consumer may use for other purposes as well (e.g. conventional tablet computers, laptops, smartphones, netbooks, etc.) with specific applications designed for vehicle-related functions stored on it. In a further implementation, the computing device may implement a walled garden operating system to execute the vehicle-related applications.

The computing device may provide the consumer with an HMI allowing the consumer to view information related to conventional instrument gauges (e.g. speedometer, tachometer, fuel meter, odometer, engine temperature, etc.), to control the heating ventilation and air conditioning (HVAC) system, to control the radio, to access infotainment services through a network (e.g. getting turn-by-turn navigation, global positioning system (GPS) information, downloading media, accessing websites, etc.), to initiate diagnostics monitoring, and to reflash vehicle modules. The computing device may further be able to log data regarding the customer or the vehicle.

In a further implementation, the computing device may further act as an avenue for entities (such as vehicle manufacturers, advertisers, service providers, authorities, and other entities that may want to interact with the consumer) to communicate messages to the consumer, market or advertise products and services to the consumer, provide the consumer with in-vehicle software upgrades, and engage in sophisticated data mining regarding the consumer or the vehicle.

In yet another further implementation, the computing device may monitor the PRNDL (gear selector, e.g., Park, Reverse, Neutral, Drive, Low) status of an automatic transmission vehicle and limit the functionality of the computing device available to the consumer based on the PRNDL status. For example, while the vehicle is in Park, the computing device may allow the consumer to have full access to all functionality of the computing device, whereas while the vehicle is in drive, the computing device may restrict the functionality accessible to the consumer to certain vehicle-specific tasks.

Other objects and advantages of the invention will become apparent upon reading the following detailed description and upon reference to the drawings.

### BRIEF DESCRIPTION OF THE SEVERAL VIEWS OF THE DRAWINGS

FIG. 1 is a schematic diagram of an operating environment for a mobile vehicle system usable in implementations of the described principles;

FIG. 2 is a flowchart illustrating the variety of functions available through a computing device in accordance with an implementation of the described principles;

FIG. 3 is a simplified schematic showing interactions between remote entities and a consumer in a vehicle in accordance with an implementation of the described principles; and

FIG. 4 is a flowchart illustrating a process for limiting the accessible functionality of a computing device based on PRNDL status in accordance with an implementation of the described principles.

### DETAILED DESCRIPTION OF THE INVENTION

Before discussing the details of the invention and the environment wherein the invention may be used, a brief overview is given to guide the reader. In general terms, not intended to limit the claims, the invention is directed to a system and method for utilizing a computing device as part of a HMI of a vehicle to provide consumers with a personalized driving experience, comprehensive infotainment services, and a more sophisticated avenue for interacting with the consumers.

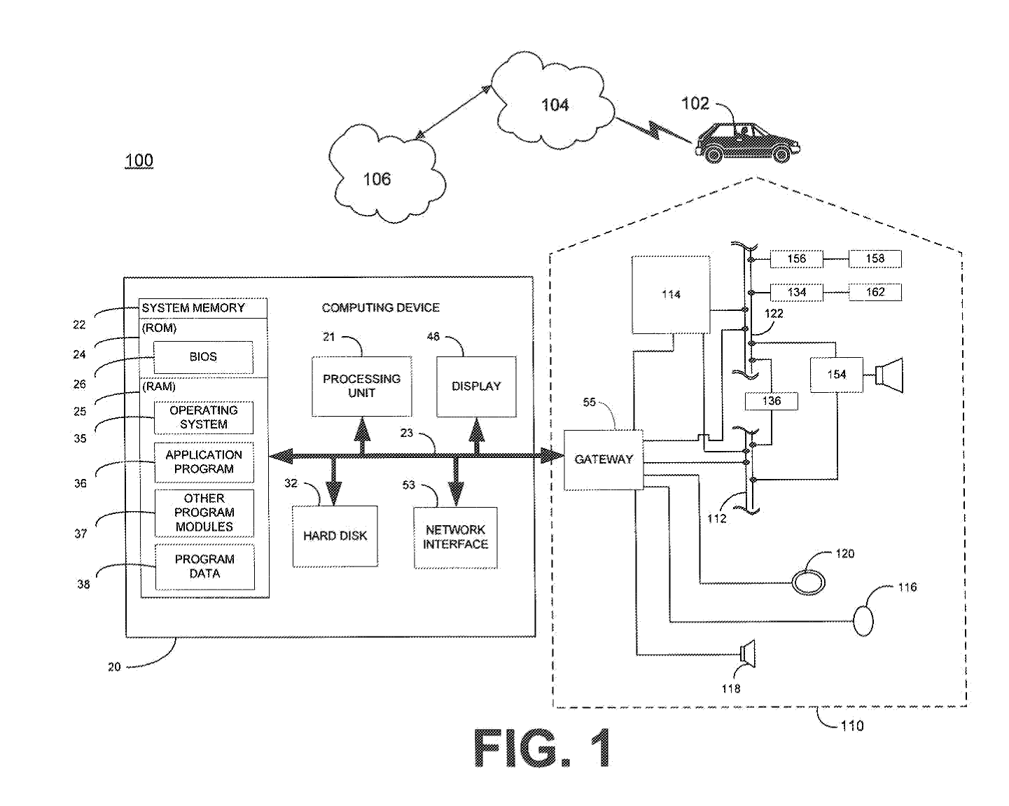

Given this overview, an exemplary environment in which the invention may operate is described hereinafter. It will be appreciated that the described environment is an example, and the components depicted do not necessarily imply any limitation regarding the use of other environments to practice the invention. With reference to FIG. 1 there is shown an example of a system 100 that may be used with the present method and system and generally includes a vehicle 102, a computing device 20, various vehicle components, and a wireless network 104. Vehicle 102 is preferably a mobile vehicle such as a motorcycle, car, truck, recreational vehicle (RV), boat, plane, etc., and is equipped with suitable hardware and software that enables it to communicate over network 104.

In a preferred implantation, the computing device 20 may be a tablet computer, but it will be appreciated that other types of computing environments maybe employed and are contemplated by this invention, including but not limited to, personal computers, hand-held or laptop devices, programmable consumer electronics, distributed'computing environments that include any of the above systems or devices, and the like.

Although not required, aspects of the invention may be described in the general context of computer-executable instructions, such as program modules, being executed by a personal computer or a computerized device, via the reading of such instructions from a non-transient computer-readable medium. Generally, program modules include routines, programs, objects, components, data structures, etc. that perform particular tasks or implement particular abstract data types. The computing device 20 in FIG. 1 illustrates an example of a suitable computing system environment that may be used to implement the invention. The depicted computing system environment is only one example of a suitable computing environment and is not intended to, suggest any limitation, as to the scope of use or functionality of the invention. Neither should the computing environment be interpreted as having any dependency or requirement relating to any one or combination of components illustrated in the exemplary operating environment.

Components of the computing device 20 may include a processing unit 21, a system memory 22, and a system bus 23 that couples various system components including the system memory to the processing unit 21. The system bus 23 may be any of several types of bus structures including a memory bus or memory controller, a peripheral bus, and a local bus using any of a variety of bus architectures. The system memory may include read only memory (ROM) 24 and random access memory (RAM) 25. A basic input/output system (BIOS) 26, containing the basic routines that help to transfer information between elements within the computing device 20, such as during start-up, may be stored in ROM 24. The computing device 20 may further include a hard disk 32. The hard disk may provide nonvolatile storage of computer readable instructions, data structures, program modules and other data for the computing device 20. It will be appreciated that although only a hard disk is depicted, computer readable instructions, data structures, program modules and other data for the computing device 20 may be stored on other non-transient computer-readable media such as magnetic disks, optical discs, flash memory, or other types of memory, accessible through, the appropriate drives.

The program modules stored on the ROM 24, RAM 25, or hard disk 32 may include an operating system 35, one or more applications programs 36, other program modules 37, and program data 38. In one implementation, a walled garden operating system may be used such that only applications and content approved by a certain entity (such as a manufacturer or service provider) may be utilized in connection with vehicle components, providing the user with assurance that the vehicle-related applications are legitimate and have been approved by a trusted entity.

A user may enter commands and information into the computing device 20 through input devices such as a touch-screen display 48 or other input devices such as a keyboard or pointing device (not depicted). Other input devices (also not depicted) may include a microphone, joystick, game pad, satellite dish, scanner, or the like. These and other input devices may be connected to the processing unit 21 through an appropriate interface such as a universal serial bus (USB). In addition to the display 48, the computer may include other peripheral output devices such as speakers and printers (not depicted). It will be appreciated that in an alternative implementation, the computing device 20 itself may not include speakers or other components, but may utilize the vehicle speakers 118 or other vehicle components.

The computing device 20 may further include a network interface 53 and appropriate hardware for accessing local area networks, wireless networks, and the Internet, and for communicating with vehicle components, other devices, or a communications gateway using other wireless technologies such as shorter-range technologies including, but not limited to, WiFi, Bluetooth, ZigBee, and RFID. In a further alternative implementation, the computing device 20 may utilize a vehicle's telecommunications module 114 and the computing device's connection with the vehicle components (which may be wired or wireless) to send and receive information over a wireless network.

The computing device 20 may be integrated or connected to the vehicle's dashboard and may communicate with vehicle systems through wired or wireless connections and directly or through a communications gateway 55. In one implementation, the computing device 20 may communicate with vehicle components through a communications gateway 55 wirelessly over short-range wireless technologies such as Bluetooth or Zigbee. In a further implementation, the computing device 20 may be a portable general purpose computing device that the user may carry around with them (such as a table computer, a smartphone, a netbook, laptop, etc.) with specific applications designed for vehicle-related functions stored on it.

In yet another further implementation, when the computing device 20 is near the vehicle or inside the vehicle, or upon request by the user, the computing device 20 may establish a connection with the vehicle systems and execute the specialized applications for communicating with vehicle components described further below. In another implementation, the computing device 20 may be physically connected to the gateway 55 or some other vehicle interface (e.g., an appropriate “plug-in” interface) to begin communication: with the vehicle systems and run the specialized vehicle applications. In a further implementation, the computing device 20 may further be detached from the vehicle and carried around with the user for other general purpose uses of the computing device 20.

It will be appreciated that while FIG. 1 depicts the communications gateway 55 and wired connections, implementations of the described principles are not limited to this depiction and components may be wirelessly connected and may not require a communications gateway. It will be appreciated that if no communications gateway is used, a different appropriate interface for the computing device 20 to communicate with the vehicle components wirelessly or through wired connection may be used. For example, a computing device 20 may interface and communicate with vehicle components through an on-board diagnostics (OBD) port.

Some of the vehicle hardware 110 is shown generally in FIG. 1 including a telecommunications module 114 (such as a telematics unit), a microphone 116, a speaker 118 and buttons and/or controls 120 connected to the telematics unit 114. Coupled to the communications gateway 55 or computing device 20 is a network connection or vehicle bus 122. Examples of suitable network connections include a controller area network (CAN), a media oriented system transfer (MOST), a local interconnection network (UN), an Ethernet, and other appropriate connections such as those that conform with known ISO, SAE, and IEEE standards and specifications, to name a few.

The telecommunications module 114 may provide a variety of services through its communication with a service provider and may further include components such as an electronic processing device, one or more types of electronic memory, a cellular chipset/component, a wireless modem, a dual antenna, and a navigation unit containing a GPS chipset/component. In one example, the wireless modem may be comprised of a computer program and/or set of software routines executing within the processing device of the telecommunications module. The cellular chipset/component and the wireless modem may be called the network access device (NAD) of the telecommunications module 114.

Various crash and or collision sensor interface modules 156 and sensors 158 may be located throughout the vehicle. Infotainment-related services where music, Web pages, movies, television programs, video games and/or other content may be downloaded via an infotainment center 136 operatively connected to the telecommunications unit 114 or communications gateway 55 via vehicle bus 122 and audio bus 112. In one example, downloaded content is stored for current or later playback.

Vehicle communications preferably use radio transmissions to establish a voice channel with wireless carrier system 104 so that both voice and data transmissions can be sent and received over the voice channel. Vehicle communications are enabled via the telecommunications module 114. In order to enable successful data transmission over the voice channel, the telecommunications module 114 may apply some type of encoding or modulation to convert the digital data so that it can communicate through a vocoder or speech codec incorporated in the cellular chipset/component of the telecommunications module 114. Any suitable encoding or modulation technique that provides an acceptable data rate and bit error can be used with the present method.

Microphone 116 provides the driver or other vehicle occupant with a means for inputting verbal or other auditory commands, and can be equipped with an embedded voice processing unit utilizing HMI technology known in the art. Conversely, speaker 118, provides verbal output to the vehicle occupants and can be either a stand-alone speaker specifically dedicated for use with the telematics unit 114 or can be part of a vehicle audio component 154. In either event, microphone 116 and speaker 118 enable vehicle hardware 110 and remote entities to communicate with the occupants through audible speech. The vehicle hardware also includes one or more buttons or controls 120 for enabling a vehicle occupant to activate or engage one or more of the vehicle hardware components 110. For example, one of the buttons 120 can be an electronic push button used to initiate voice communications. In another example, one of the buttons 120 can be used to initiate emergency services.

The audio component 154 is operatively connected to the vehicle bus 122 and the audio bus 112. The audio component 154 receives analog information, rendering it as sound, via the audio bus 112. Digital information is received via the vehicle bus 122. The audio component 154 provides AM and FM radio, CD, DVD, and multimedia functionality independent of the infotainment center 136. Audio component 154 may contain a speaker system, or may utilize speaker 118 via arbitration on vehicle, bus 122 and/or audio bus 112.

The vehicle crash and/or collision detection sensor interface 156 are operatively connected to the vehicle bus 122. The crash sensors 158 provide information to the telematics unit 114 via the crash and/or collision detection sensor interface 156 regarding the severity of a vehicle collision, such as the angle of impact and the amount of force sustained.

Vehicle sensors 162, connected to various sensor interface modules 134 are operatively connected to the vehicle bus 122. Example vehicle sensors include but are not limited to gyroscopes, accelerometers, magnetometers, emission detection and/or control sensors, and the like. Example sensor interface modules 134 include power train control, climate control, and body control, to name but a few.

Wireless carrier system 104 is preferably a cellular telephone system or any other suitable wireless system that transmits signals between the vehicle hardware 110 and land network 106. According to an example, wireless carrier system 104 includes one or more cell towers, base stations and/or mobile switching centers (MSCs), as well as any other networking components required to connect the wireless system 104 with land network 106. A component in the mobile switching center may include a remote data server.

As appreciated by those skilled in the art, various cell tower/base station/MSC arrangements are possible and could be used with wireless system 104. For example, a base station and a cell tower could be co-located at the same site or they could be remotely located, and a single base station could be coupled to various cell towers or various base stations could be coupled with a single. MSC, to but a few of the possible arrangements. Preferably, a speech codec or vocoder is incorporated in one or more of the base stations, but depending on the particular architecture of the wireless network, it could be incorporated within a Mobile Switching Center or some other network components as well.

Land network 106 can be a conventional land-based telecommunications network that is connected to one or more landline telephones and connects wireless carrier network 104 to remote entities. For example, land network 106 can include a public switched telephone network (PSTN) and/or an Internet protocol (IP) network, as is appreciated by those skilled in the art. Of course, one or more Segments of the land network 106 can be implemented in the form of a standard wired network, a fiber or other optical network, a cable network, other wireless networks such as wireless local networks (WLANs) or networks providing broadband wireless access (BWA), or any combination thereof.

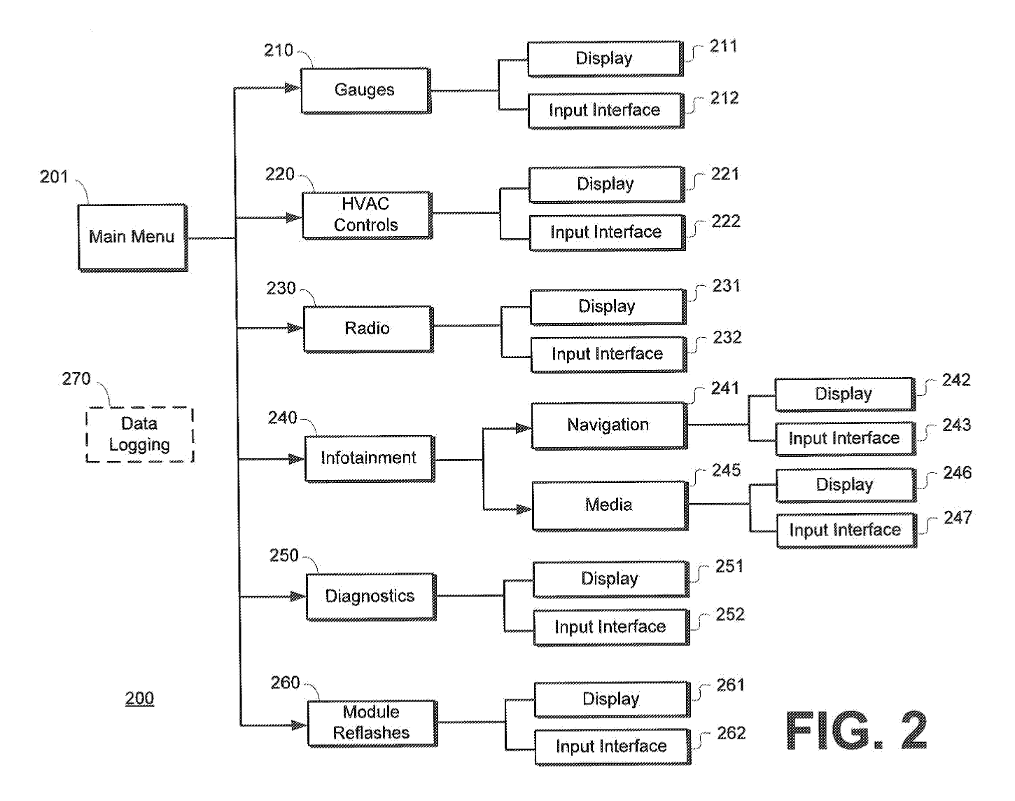

With continued reference to the architecture of FIG. 1 while turning more specifically to FIG. 2, a flowchart 200 is depicted which shows exemplary functions that are accessible through a computing device HMI in accordance with an implementation of the described principles. A main menu 201 or other, type of initial interface may be displayed to a user of the computing device, the main menu 201 providing a mechanism through which a number of functions or applications are made accessible to the user through a plurality of particular functional interfaces.

The main menu 201 may appear when the computing device is connected to the vehicle, when the user starts up a vehicle-related application on the computing device, when the vehicle is started, or upon the occurrence of one or more other triggers. The main menu 201 may include buttons for accessing more specific interfaces, and may further include a display showing some of the information related to vehicle status and operation included in the more specific interfaces described below.

From the exemplary main menu 201 depicted in FIG. 2, a number of options may be available to the user. For example, there may be a button that allows the user to view vehicle gauges, and pressing that button may bring up a vehicle gauge interface 210 which includes a display 211 showing certain gauges or information relating to such gauges, including but not limited to speedometers, tachometers, fuel meters, odometers, engine temperatures, etc.

The user may further be able to use the interface to input options 212 such as adjusting the viewing options and performing certain functions such as, for example, resetting an trip odometer. It will be appreciated that the input interface 212 may or may not be part of the display (e.g. touchscreen buttons or buttons outside of the display). It will further be appreciated that while buttons are described herein for controlling the computing device, other input devices, including but not limited to keyboards, pointing devices, microphones, and the like, may be used to navigate the computing device as well. The vehicle gauge interface 210, as well as the other interfaces described below, may further include a button for returning to the main menu 201 to access the other specific interfaces, or may include buttons to access the other specific interfaces directly.

From the main menu 201, the user may also be able to access an HVAC control interface 220 which may include a display 221 for showing the user certain information such as, for example, current HVAC settings and current temperature. In an implementation, the HVAC control interface 220 further includes an input interface 222 that may be used to adjust the HVAC controls. The user may also access a radio interface 230 from the main menu 201 which includes a display 231 showing radio-related information such as, for example, the current station setting, volume, and preset information, and may further include an input interface 232 for controlling the radio.

The specific function-based interfaces may be divided further into other interfaces, such as, for example, an infotainment control interface 240, which may further direct the user to a navigation control interface 241 and a media control interface 245. For example, if the user is at the main menu 201 and wishes to obtain turn-by-turn directions, the user may select an option leading the user to the infotainment interface 240, and then further select an option leading to the navigation interface 241. The navigation interface 241 may then include an input interface 243 for The user toy input a destination and a display 242 for displaying directions to enable the user to travel to that destination. The user can similarly access a media control interface 245 which may include an input interface 247 allowing the user to command the computing device to do such tasks as downloading and playing media, and a display 246 for displaying the media or showing download progress.

Other specific interfaces may include a diagnostics interface 250, through which a user can use inputs 252 to view the status of different vehicle components and systems on a diagnostics display 251, and a module reflash interface 260, through which a user can use inputs 262 to reflash different vehicle components and view status information on a module reflash display 261.

In an implementation, the computing device further performs data logging 270 and mining in the background regarding user behavior and vehicle status. The computing device may further analyze or send the logged data to one or more remote entities, in order that these remote entities or the user may use the data to improve the user's driving experience.

It will be appreciated that the options depicted in FIG. 2 are exemplary and not intended to be limiting, and that different functions and options may be incorporated with other implementations of the described principles. For example, other implementations may include a telecommunications interface for conducting in-vehicle calls, or an emergency interface for handling emergency situations.

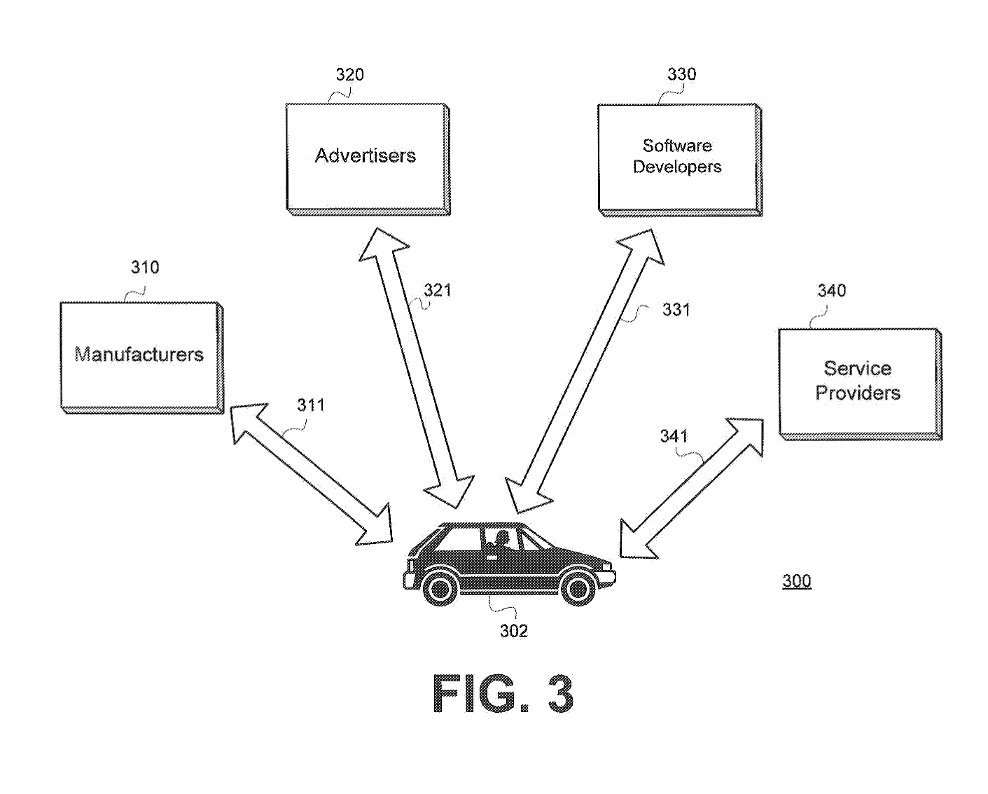

With further reference to the architecture of FIG. 1, and turning now more specifically to FIG. 3, a simplified schematic 300 is depicted showing exemplary remote entities that may communicate with the computing device associated with the vehicle 302 in accordance with an implementation of the described principles. For example, vehicle and vehicle component manufacturers 310 may wish to receive data 311 from the vehicle 302 regarding, for example, operation and usage of certain vehicle systems and components, and may further wish to send updates 311 to the vehicle 302 to ensure optimal operation of those components or systems.

Advertisers 320 may also wish to take advantage of the capabilities of the computing device to interact with users of the computing device. For example, advertisers 320 may receive certain data 321 from the computing device regarding the user and may use that data to send 321 marketing messages and advertisements particularly directed towards that user, such as, advertisements based on the user's location, frequently visited destinations, driving habits, vehicle status, or other user-related information.

Software developers 330, which may develop and update applications for the computing device may, similar to manufacturers and advertisers, wish to receive information 331 from the user 302 and to send 331 updates or advertising to the user 302. Service providers 340, such as for example wireless carriers or telematics service providers, may also communicate 341 with the computing device to facilitate the provision of services, such as infotainment, and to monitor user activity and receive requests from the user.

It will be appreciated that the remote entities depicted in FIG. 3 may be central or remote facilities, manned or unmanned, mobile or fixed, to or from which it is desirable to exchange voice and data. It will further be appreciated that the entities may or ay not be distinct from one another. For example, in many instances, manufacturers, software developers, and service providers may act as advertisers in sending advertisements directed at the user, or manufacturers, advertisers, and service providers may act as software developers in developing and updating applications for the computing device.

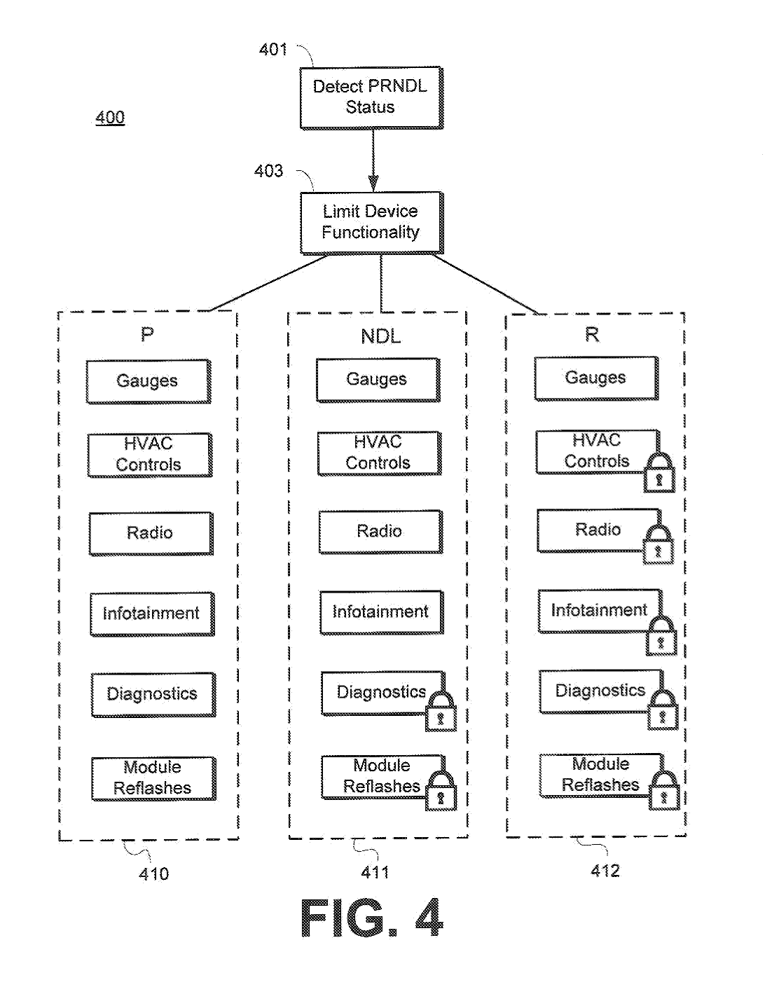

With further reference to the architecture of FIG. 1 and the features of FIG. 2, and turning more specifically to FIG. 4, a simple flowchart is depicted that shows a process 400 for limiting the accessible functionality of a computing device based on PRNDL status of a vehicle. The computing device communicates with vehicle components to determine the PRNDL status of the vehicle 401, i.e., whether the vehicle's transmission is in a Park, Reverse, Neutral, Drive, or Low setting.

The computing device may then further execute instructions stored on the computing device to limit the computing device's functionality 403 based on the status that it detects and the respective programming of the computing device. For example, in an implementation depicted by FIG. 4, if the computing device detects that the vehicle is in Park 410, all functionality is freely accessible to a user of the computing device. If the computing device detects that the vehicle is in Neutral, Drive, or Low, certain functionality may be restricted 411. In this implementation, the diagnostics monitoring and module reflashing is restricted, as using those functions on the computing device may present a distraction given their relative complexity. If the computing device detects that the vehicle is in Reverse, nearly all functionality may be restricted as depicted 412, with only the vehicle gauge interface being accessible to the user. The computing device may be programmed in such a manner based on the recognition of a greater need for driver focus when the vehicle is being driven in reverse.

It will be appreciated that the implementation depicted by FIG. 4 is merely exemplary, and other combinations of functionality and PRNDL status may be used. For example, in other implementations, the NDL statuses may each have their own set of restrictions, and the restrictions programmed for the PRNDL statuses may be different from those depicted.

It will be appreciated that the described system and method allows for utilization of a computing device as part of a HMI of a vehicle to provide consumers with a personalized driving experience, comprehensive infotainment services, and a more sophisticated avenue for interacting with the consumers. It will also be appreciated, however, that the foregoing methods and implementations are merely examples of the inventive principles, and that these illustrate only preferred techniques.

It is thus contemplated that other implementations of the invention may differ in detail from foregoing examples. As such, all references to the invention are intended to reference the particular example of the invention being discussed at that point in the description and are not intended to imply any limitation as to the scope of the invention more generally. All language of distinction and disparagement with respect to certain features is intended to indicate a lack of preference for those features, but not to exclude such from the scope of the invention entirely unless otherwise indicated.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A system providing a human machine interface (HMI) between a user and a vehicle, the system comprising:
a vehicle, including a plurality of vehicle components and having a vehicle passenger compartment; and
a computing device adapted for communicating with the plurality of vehicle components and capable of being freely removed from within the vehicle passenger compartment without deinstallation, the computing device further comprising:
a screen adapted for displaying information relating to the plurality of vehicle Components to the user;
an input adapted for receiving requests from the user; and
memory for storing vehicle-related applications.

2. The system of claim 1, wherein the computing device communicates wirelessly with the vehicle components.

3. The system of claim 2, wherein the computing device utilizes at least one of WiFi, Bluetooth, and ZigBee for wireless communication with the vehicle components.

4. The system of claim 2, wherein the computing device detects when the vehicle is within a predetermined proximity to the computing device and automatically begins running at least one vehicle-related application.

5. The system of claim 1, wherein the computing device communicates with the vehicle components through a communications gateway.

6. The system of claim 1, wherein the computing device communicates with the vehicle components through a detachable wired connection.

7. The system of claim 1, wherein the computing device is a tablet computer.

8. The system of claim 1, wherein the computing device utilizes a walled garden operating system with respect to the vehicle-related applications.

9. The system of claim 1, wherein the screen is adapted to display a plurality of functional interfaces, wherein the functional interfaces relate to the plurality of vehicle components.

10. The system of claim 1, further comprising:
a remote entity, adapted to communicate with at least one of the vehicle and the computing device over a network.

11. The system of claim 10, wherein the remote entity is further adapted to send at least one of advertising messages and software updates to the computing device.

12. The system of claim 11, wherein the computing device is further adapted to mine data relating to at least one of the user and the plurality of vehicle components, the remote entity being further adapted to receive the mined data, and the at least one of advertising messages and software updates sent to the computing device being based on the mined data.

13. The system of claim 1, wherein the computing device is further adapted to detect a gear selector status of the vehicle, and wherein the functionality of the computing device available to the user is limited based on the detected gear selector status.

14. A removable computing device temporarily connected to a vehicle, the removable computing device including a display, at least one input interface, and a non-transient computer readable medium having thereon computer executable instructions for providing a human machine interface (HMI) between a user of the vehicle and the vehicle, the computer executable instructions comprising:
instructions for receiving at least one user request through the at least one input interface;
instructions for communicating with vehicle components based on the at least one user request;
instructions for displaying information related to vehicle components to the user through the display based on the at least one user request; and
instructions for providing the user with one of a plurality of functional interfaces related to vehicle operation through the display based on the at least one user request.

15. The removable computing device of claim 14, wherein the computer executable instructions further comprise:
instructions for mining data related to the user and to the vehicle.

16. The removable computing device of, claim 15, wherein the computer executable instructions further comprise:
instructions for sending the mined data to one or more remote entities over a network; and
instructions for receiving at least one of advertising messages and software updates to the computing device.

17. The removable computing device of claim 14, wherein the computer executable instructions further comprise:
instructions for retrieving a gear selector status of the vehicle; and
instructions for limiting the functionality of the computing device available to the user based on the retrieved gear selector status.

18. The removable computing device of claim 14, wherein the removable computing device is a tablet computer.

19. A method for limiting accessible functions of a removable computing device connected to a vehicle, the method comprising:
detecting, at the removable computing device, a gear selector status of the vehicle; and
restricting, at the removable computing device, access to certain functions of the computing device to a user of the computing device based on the detected gear selector status.

20. The method of claim 19, wherein the removable computing device is a tablet computer.
